(19) United States
(12) Patent Application Publication
(10) Pub. No.: US 2025/0384226 A1
(43) Pub. Date: Dec. 18, 2025

(54) Multilingual Dataset Collection For Large Language Model Training

(71) Applicant: Zoom Communications, Inc., San Jose, CA (US)

(72) Inventors: Ravi Agrawal, Pacifica, CA (US); Shamil Chollampatt Muhammed Ashraf, Singapore (SG); Sathish Reddy Indurthi, San Jose, CA (US); Kaiqiang Song, Redmond, WA (US); Lingxiao Zhao, Pittsburgh, PA (US); Wenxuan Zhou, Los Angeles, CA (US); Chenguang Zhu, Issaquah, WA (US)

(21) Appl. No.: 18/883,706

(22) Filed: Sep. 12, 2024

Related U.S. Application Data
(60) Provisional application No. 63/660,168, filed on Jun. 14, 2024.

(51) Int. Cl. G06F 40/58; G06F 40/279; G06F 40/49; G06F 40/51; G06N 3/0895

(52) U.S. Cl. CPC G06F 40/58; G06F 40/279; G06F 40/49; G06F 40/51; G06N 3/0895

(57) ABSTRACT

Multilingual dataset collection for large language model (LLM) training is performed to prepare a dataset in each of multiple target languages according to source responses obtained and high-quality instructions generated for those responses. Responses in the target language from one or more response sources and translated into English to produce English responses. For each English response, a first LLM is prompted to generate an English instruction for which the English response is a valid answer. For each English response and corresponding instruction pair, a score for the pair is compared against a threshold, and, where the score meets the threshold, the English instruction of the pair is translated into the target language, in which each instruction in the target language and the respective response in the target language are a final pair. A training dataset including the final pairs is then output for training a second LLM.

### CROSS-REFERENCE TO RELATED APPLICATION(S)

This application claims the benefit of U.S. Provisional Application Ser. No. 63/660,168, filed Jun. 14, 2024, the entire disclosure of which is herein incorporated by reference.

### FIELD

This disclosure generally relates to an artificial intelligence (AI) system, and, more specifically, to multilingual dataset collection for large language model (LLM) training.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of an example of an AI system for processing user requests associated with software services of a software platform.

FIG. 5 is a block diagram of an example of multilingual dataset collection functionality of an AI system.

FIG. 6 is a flowchart of an example of a technique for multilingual dataset collection for LLM training.

### DETAILED DESCRIPTION

Enterprise entities rely upon several modes of communication to support their operations, including telephone, email, internal messaging, and the like. These separate modes of communication have historically been implemented by service providers whose services are not integrated with one another. The disconnect between these services, in at least some cases, requires information to be manually passed by users from one service to the next. Furthermore, some services, such as telephony services, are traditionally delivered via on-premises solutions, meaning that remote workers and those who are generally increasingly mobile may be unable to rely upon them. One solution is by way of a unified communications as a service (UCaaS) platform, which includes several software services corresponding to multiple communications modalities integrated over a network, such as the Internet, to deliver a complete communication experience regardless of physical location. The software services of a UCaaS platform may thus enable synchronous and asynchronous communications between users. In some cases, the software services of a UCaaS platform may implement other functionality as well, for example, for using digital whiteboards, making workspace reservations, or the like.

A software platform, such as a UCaaS platform, may provide AI functionality for use with the software services thereof. Use of the AI functionality may enhance the user experience by automating processes, answering prompted questions with minimal or no disruption to an active communication session, or introducing capabilities previously unavailable to software service users. The AI functionality is implemented using one or more models (e.g., machine learning models), which may be trained to process specific types of input and produce specific types of output. The AI functionality may be implemented in a variety of use cases (e.g., language processing, image feature extraction, cyberthreat detection, or recommendation production), using a variety of approaches (e.g., supervised learning, unsupervised learning, or reinforcement learning), and in a variety of structures (e.g., a neural network, decision tree, linear regression, vector machine, Bayesian network, genetic algorithm, or deep learning system).

In one non-limiting example, AI functionality enabled for use during a video conference may be implemented using a large language model (LLM) trained to obtain user requests as natural language processing (NLP) prompts and to produce output responsive to the user requests in a same language as that which the prompts are obtained. In one non-limiting example, a video conference participant who joins the video conference after it began may submit a user request to a LLM to ask for a summary of the discussion that occurred during the video conference before the participant joined. The LLM may evaluate a real-time transcription of the video conference (e.g., produced using automated speech recognition or a like tool) to present output concisely summarizing that discussion.

Recent work in NLP leverages LLMs to assist in instruction-following, that is, the processing of instructions by LLMs to achieve some desired outcome. These LLMs are predominantly trained in the English language given the widespread global use of that language in social, business, and other settings. Typical approaches for instruction-following processing using an LLM includes, after a pretraining stage, further training the LLM using a number of Instruction Fine-Tuning (IFT) datasets which involve the collection of prompt-completion pairs. Because LLMs are predominantly trained in the English language, these IFT datasets are also generally collected and provided in the English language. Noting that there are thousands of languages spoken worldwide, this commonly results in an imbalance in training datasets that leads to suboptimal performance in non-English contexts. To improve the performance of LLMs for non-English languages, studies have explored the availability of fine-tuning LLMs on multilingual IFT datasets. In particular, two approaches have been used in recent times to create multilingual IFT datasets—translating and templating.

The translating approaches involve translating English IFT datasets into any number of target languages so that the translated versions of those IFT datasets can be used for fine-tuning for LLMs configured in each of those target languages. However, these many languages use different syntax and semantics from one another, sometimes with very different rules or nuances in grammar and/or vocabulary. These translating approaches generally use synthetic translations generated by another AI model. Unfortunately, besides being computationally expensive to generate, these synthetic translations are prone to non-trivial error due to the failure of the generating model to understand the many complexities in language variation. Thus, when an LLM is trained using a translated IFT dataset that includes errors, the LLM will indiscriminately absorb these errors and ultimately produce suboptimal or even incorrect results.

The templating approaches involve templatizing an IFT dataset so that certain content will be included therein. Large amounts of multilingual data can be automatically created following a template. However, these templates are manually created by humans and thus suffer from a tedious manual process, resulting in only so many being produced and the ones that are produced having a lack of diversity in the contents thereof. In some cases, the same instruction may be repeated thousands of times within a dataset produced by templating, which materially limits the diversity of the dataset and thus the value in using the same for LLM training.

Implementations of this disclosure address problems such as these using a novel framework for multilingual dataset collection for LLM training. The implementations of this disclosure leverage English-focused LLMs, monolingual corpora, and a scoring function to create high-quality diversified IFT datasets that preserve linguistic naturalness and ensure prompt diversity in each of multiple, non-English target languages. To generate a dataset for a target language, the framework first includes selecting responses, including unlabeled data, in the target language from a web corpus and answers sourced from existing corpora for the target language. The responses are translated into English, and pseudo-instructions are generated in English to create pairs of ones of the instructions and the responses. The quality of each of the pairs is then evaluated using a scoring function to determine the instructions which are of a reasonably high quality and thus are suitable for use in fine-tuning an LLM. The high scoring instructions are then translated from English into the target language, in particular, by generating a training pair using the English input and the translated output representing natural text in a specific language.

The implementations of this disclosure do not suffer from the drawbacks introduced by the translating and templating approaches described above. In particular, because the instructions generated according to the implementations of this disclosure are generated directly from the original multilingual responses sourced for the IFT dataset generation, the naturalness and nuances of the many target languages are preserved and instructions included in the dataset are materially diverse. Experiments corroborate that models trained on IFT datasets collected (i.e., generated or otherwise prepared) through using the implementations of this disclosure show notable improvements in generative and discriminative tasks, indicating better language comprehension of LLMs in non-English language contexts.

In some examples of this disclosure, implementations may include or otherwise use one or more artificial intelligence or machine learning (collectively, AI/ML) systems having one or more models trained for one or more purposes. Use or inclusion of such AI/ML systems, such as for implementation of certain features or functions, may be turned off by default, where a user, an organization, or both must opt-in to utilize the features or functions that include or otherwise use an AI/ML system. User or organizational consent to use the AI/ML systems or features may be provided in one or more ways, for example, as explicit permission granted by a user prior to using an AI/ML feature, as administrative consent configured by administrator settings, or both. Users for whom such consent is obtained can be notified that they will be interacting with one or more AI/ML systems or features, for example, by an electronic message (e.g., delivered via a chat or email service or presented within a client application or webpage) or by an on-screen prompt, which can be applied on a per-interaction basis. Those users can also be provided with an easy way to withdraw their user consent, for example, using a form or like element provided within a client application, webpage, or on-screen prompt to allow individual users to opt-out of use of the AI/ML systems or features.

To enhance privacy and safety, as well as provide other benefits, the AI/ML processing system may be prevented from using a user's or organization's personal information (e.g., audio, video, chat, screen-sharing, attachments, or other communications-like content (such as poll results, whiteboards, or reactions)) to train any AI/ML models and instead only use the personal information for inference operations of the AI/ML processing system. Instead of using the personal information to train AI/ML models, AI/ML models may be trained using one or more commercially licensed data sets that do not contain the personal information of the user or organization.

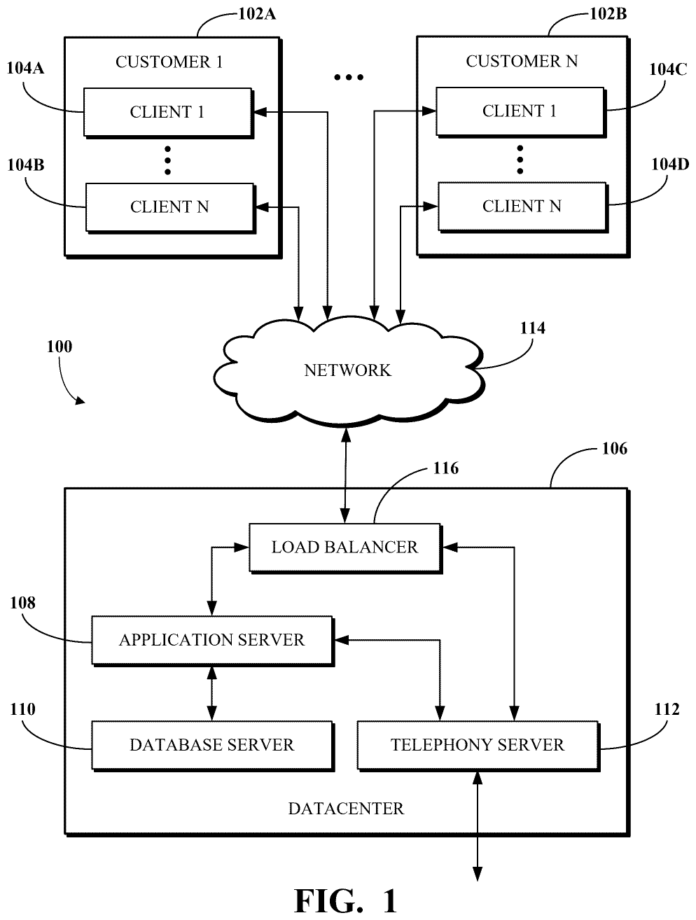

To describe some implementations in greater detail, reference is first made to examples of hardware and software structures used to implement a system for multilingual dataset collection for LLM training. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a UCaaS platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104 or the application server 108.

The telephony server 112 enables network-based telephony and web communications from and/or to clients of a customer, such as the clients 104A through 104B for the customer 102A or the clients 104C through 104D for the customer 102B. For example, one or more of the clients 104A through 104D may be voice over internet protocol (VOIP)-enabled devices configured to send and receive calls over a network 114. The telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, a SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, a SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

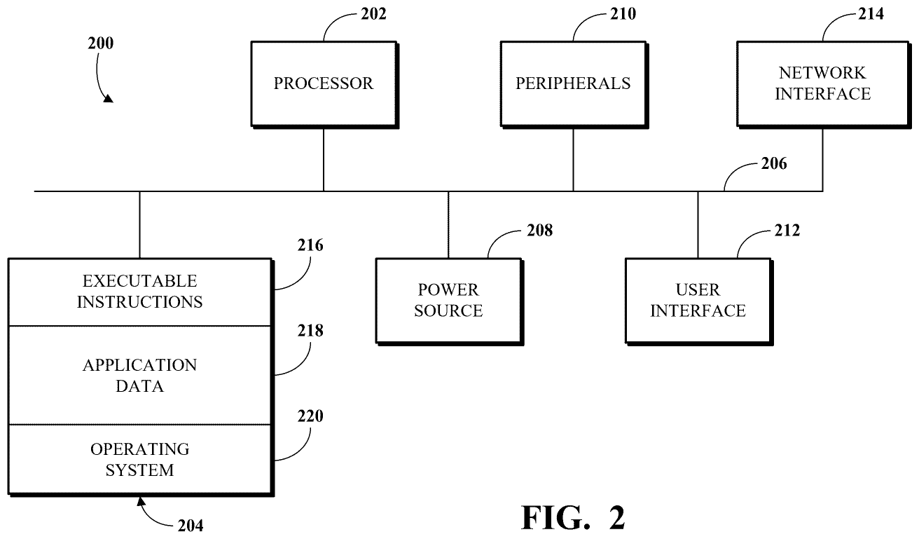

FIG. 2 is a block diagram of an example internal configuration of a computing device 200 of an electronic computing and communications system. In one configuration, the computing device 200 may implement one or more of the client 104, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

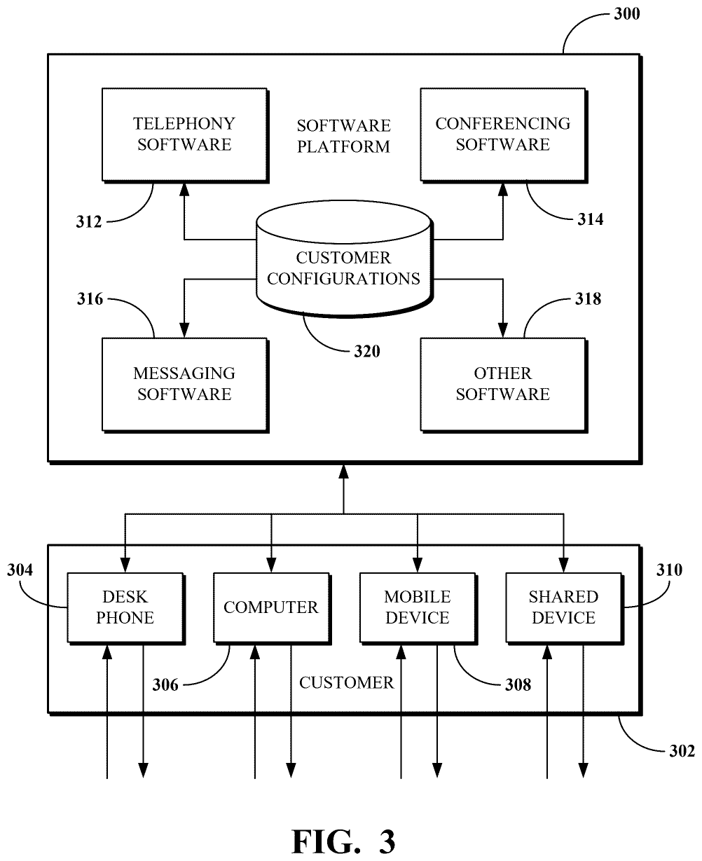

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients-a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a call in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools, but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include multilingual dataset collection software for LLM training.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the software 312 through 318 may be combined into a single software application run on clients of the customer, such as one or more of the clients 304 through 310.

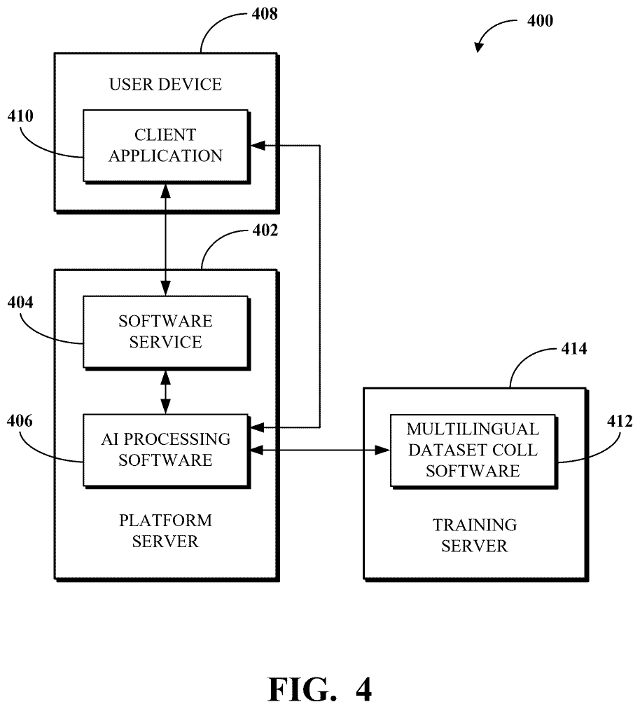

FIG. 4 is a block diagram of an example of an AI system 400 for processing user requests associated with software services of a software platform, for example, the software platform 300 shown in FIG. 3. The AI system 400 includes a platform server 402 that implements a software service 404 and AI processing software 406 that uses one or more AI (e.g., machine learning) models in connection with the software service 404. For example, the AI processing software 406 may use various LLMs each trained using a dataset collected for a different target language. The platform server 402 may, for example, include one or more application servers and/or database servers, such as the application server 108 and the database server 110 shown in FIG. 1, used to implement the software service 404 and the AI processing software 406. In some cases, the platform server 402 may be or otherwise include multiple servers. In such a case, the software service 404 and the AI processing software 406 may be implemented across the multiple servers in one or more ways.

The software service 404 is, includes, or otherwise refers to the components used to run (e.g., execute or interpret) application-level software. For example, the software service 404 may facilitate synchronous or asynchronous communications, such as via one of the software services 312 through 316 shown in FIG. 3. In another example, the software service 404 may facilitate functionality directly related, indirectly related, or unrelated to synchronous or asynchronous communications, such as appointment scheduling, event hosting, knowledgebase compilation, digital whiteboarding, workspace reservation, and the like. The software service 404 may thus be one of many software services of the software platform, in which some or all of those other software services may also be implemented by the platform server device 402 or by one or more other server devices associated with the software platform.

The software service 404 is accessed by a user device 408, which is a personal or shared computing device configured to run a client application 410 associated with the software service 404. For example, the user device 408 may be one of the clients 304 through 310 shown in FIG. 3. The client application 410 may be a software application installed on the user device 408 and used to access the various software services of the software platform via one or more client-side graphical user interfaces (GUIs). Alternatively, the client application 410 may be a web-based application instantiated based on requests processed in connection with a web browser running at the user device 408. In some implementations, the client application 410 may be omitted, in which case the user device 408 may instead access the software service 404 using other web browser-based approaches or a different software application.

In one non-limiting example, the software service 404 may correspond to conferencing software (e.g., the conferencing software 314 shown in FIG. 3) for facilitating video conferences between users of user devices including the user device 408. The user of the user device 408 connects to the video conference via the client application 410, which interfaces with the software service 404 to cause the user device 408 to join the video conference and thus enable synchronous communications over video and/or audio with the users of the other user devices. For example, the client application 410 may encode a video stream captured at the user device 408 and transmit the encoded video stream for rendering at the other user devices, and it may similarly receive encoded video streams originating at those other user devices and decode same to render the video of the other user device users at the user device 408. The user of the user device 408 may similarly use the client application 410 to access related functionality of the video conference, for example, chat tools for interacting with one or more participants via text, AI tools for summarizing video conference content, and the like.

The software service 404 may receive user requests initiated at the user device 408. The user requests are related to functionality of the software service 404 and correspond to tasks to be actioned by or otherwise on behalf of the software service 404, to generate and transmit responses to the user requests. Non-limiting examples of user requests include requests to summarize video conference content, requests to schedule an appointment or reserve a workspace, requests to classify digital whiteboards by content or creator, and the like. A user request may be initiated at the user device 408 in one or more ways, including, for example, by the user device 408 obtaining input from a user thereof, such as in response to a prompt. The user requests obtained from a given user device, such as the user device 408, may be in any of various languages for which the AI processing software 406 is configured using multilingual datasets.

The AI processing software 406 obtains such a user request from the software service 404 and causes an AI model (e.g., an LLM) to process the user request to produce output responsive to the user request. The AI processing software 406 then transmits the output to the software service 404 for the software service 404 to present to the user device 408. In some cases, the client application 410 may directly interface with the AI processing software 406 (i.e., without using the software service 404 as an intermediary or otherwise).

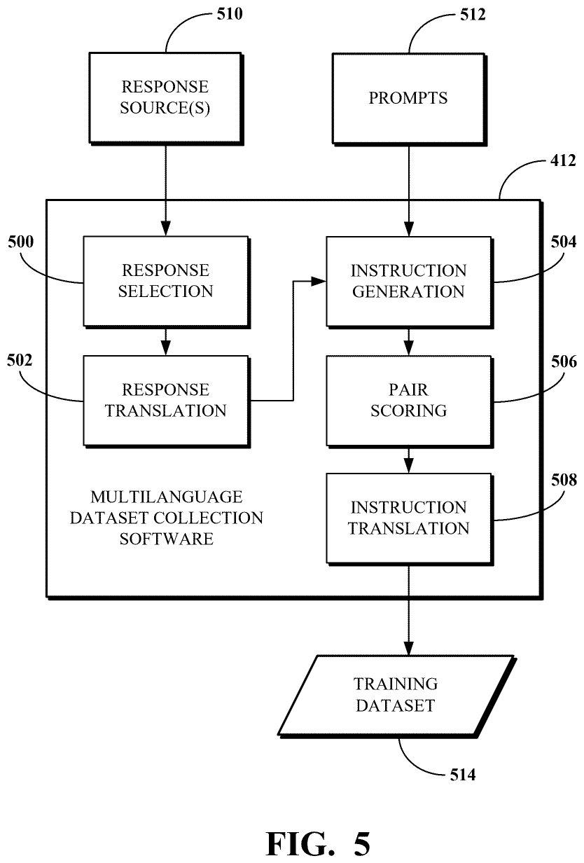

An AI model used by the AI processing software 406, such as an LLM, may be trained using a dataset (e.g., an IFT dataset) collected (e.g., generated or otherwise prepared) using multilingual dataset collection software 412. The multilingual dataset collection software 412 collects datasets in each of multiple target languages for use in the fine-tuning of individual LLMs each directed to one of those target languages. The multilingual dataset collection software 412 leverages English-focused LLMs, monolingual corpora, and a scoring function to create high-quality datasets that preserve linguistic naturalness and ensure prompt diversity in each of multiple, non-English target languages. The multilingual dataset collection software 412 will be further described with respect to FIG. 5. The multilingual dataset collection software 412 is shown as being implemented at a training server 414 that is separate from the platform server 402. For example, the training server 414 may be another server under the control, operation, or other use of a same entity that operates the software platform associated with the platform server 402. However, in some cases, the multilingual dataset collection software 412 may be implemented at the platform server 402 or a different location altogether.

In some implementations, a dataset collected using the multilingual dataset collection software 412 may be used to train an AI model for use other than with the software platform associated with the platform server 402. For example, a dataset collected using the multilingual dataset collection software 412 may be transmitted to an external server or other location for training an LLM unrelated to the software platform. In some implementations, the AI system 400 may omit the user device 408 and the platform server 402. For example, the AI system 400 may instead be directed to the multilingual dataset collection software 412 and use thereof to collect datasets for use in training LLMs elsewhere.

In some implementations, the AI processing software 406 may cause an execution of one or more AI models external to the software platform associated with the platform server 402. For example, the external AI models may be LLMs or other models under the control, operation, or other use by an entity separate from the software platform associated with the platform server 402. The AI processing software 406 may cause an execution of such an external model by transmitting a request, for example, via an application programming interface (API) call, to external software, which is frontend and/or backend software associated with the implementation of the external model and which is run at an external server. The external software then executes, or otherwise causes an execution of, the external model based on the request to cause the external model to perform an inference operation against that input. The external software obtains the output produced based on the inference operation and passes that output to the AI processing software 406.

FIG. 5 is a block diagram of an example of multilingual dataset collection functionality of the AI system 400 shown in FIG. 4. In particular, the multilingual dataset collection functionality is expressed with respect to the multilingual dataset collection software 412 shown in FIG. 4. The multilingual dataset collection software 412 includes tools, such as programs, subprograms, functions, routines, subroutines, operations, and/or the like, for collecting multilingual datasets usable for training LLMs in various target languages. As shown, the multilingual dataset collection software 412 includes a response selection tool 500, a response translation tool 502, an instruction generation tool 504, a pair scoring tool 506, and an instruction translation tool 508.

The response selection tool 500 selects responses, R, to be used for the dataset collection from one or more response sources 510. The one or more response sources 510 are web corpora from which unlabeled data in a target language may be obtained. A response source 510 may, for example, be an online website at which multiple language versions of the same content may be obtained, such as a multilingual online encyclopedia including the same article for each of many various languages. There may in some cases be multiple response sources 510 used in which some may provide supplementary response content, for example, a question and answer set manually created in the target language by a human. Obtaining the responses includes processing a response source 510 to identify and extract therefrom self-contained segments of text each including one or more sentences. Briefly, a text segment is considered to be self-contained where it does not refer to a source outside of the text segment (e.g., via a hyperlink or footnote). In some cases, a further filtering or like processing may be performed against the text segments to cull low-quality segments, for example, based on the presence or prevalence of capitalized letters, specialized symbols, or other text content that corresponds to filter criteria. The self-contained segments extracted from the response source 510, and in some cases as further filtered, are then selected as the responses.

The response translation tool 502, to support the high-quality and diverse English instruction generation from English-based LLMs, translates each response, R, selected by the response selection tool 500 from its target language into English as:

$${R}_{EN} = {MT}_{X \to EN} ( R ) \qquad ( 1 )$$

The response translation tool 502 uses a machine translation model to translate each given response, R, into an English response, R_{EN}, as described above. The machine translation model may be an AI model prepared by the software platform that uses the multilingual dataset collection software 412 or it may be an AI model available via a third party (e.g., as an open source AI tool). Generally, the machine translation model uses X to X functionality to translate from a first language (e.g., the target language) into a second language (e.g., English).

The instruction generation tool 504 generates, for each English response, R_{EN}, an instruction, I_{EN}, which is an instruction that may be given to an LLM to cause the LLM to output the English response. The instruction generation tool 504 uses the English responses and prompts 512 as input to an LLM configured for instruction generation to generate the instructions for the various English responses. The prompts 512 may, for example, be manually created or machine generated. In particular, a prompt for a given instruction, P_{I}, is itself an instruction that will be processed by an LLM used by the instruction generation tool 504 for a given response as:

$${I}_{EN} = LLM ( {P}_{I} , {R}_{EN} ) \qquad ( 2 )$$

The prompt, P_{I}, for a given English response, R_{EN}, is thus a request for the LLM to generate the instruction, I_{EN}, for the English response so that the English response can be a valid answer for the instruction. Non-limiting examples of what the instruction may be include a task for answering a knowledge-based question (e.g., who is the President of the USA or a math question), a tasks for translating (e.g., please translate this content to Spanish), a task for summarizing some amount of content, or a task for evaluating the sentiment of the content.

In any event, the task associated with the prompt is processed to result in the corresponding English response. For example, where the English response is a paragraph explaining the potential harms of excessive mobile phone use, the instruction may be a request for information about, or a question asking, whether it is okay to excessively use a mobile phone. The prompt is text usable by the LLM to generate that instruction. In some cases, the English response may have multiple relevant instructions that could be used with it, and so the prompt may be open ended to encourage creativity of the LLM in producing various plausible instructions for a given prompt, P_{I}, and English response, R_{EN}. For example, the English response may simply be the number 50 and the instruction generated could be a question asking how many states there are in the US or the answer of 27 plus 23.

Thus, the prompt is text that guides the LLM used by the instruction generation tool 504 to generate the instruction, I_{EN}. In some cases, the prompt may be randomly selected from a set of prompts. For example, a set of prompts may be specifically tailored to support various NLP tasks in the target language, including question answering, summarization, or sentiment analysis. Once the instruction, I_{EN}, is generated, it is combined with the English response, R_{EN}, and identified as a pair (I_{EN}, R_{EN}). This pairing may be performed by the instruction generation tool 504 or another aspect of the multilingual dataset collection software 402.

The pair scoring tool 506 obtains the many pairs (I_{EN}, R_{EN}) and evaluates them to determine whether they meet a threshold. The threshold, which may be static or dynamic and may be pre-defined or defined on-the-fly, represents a quality measurement for instruction and response pairs. In particular, evaluation of a given pair against the threshold is performed to determine whether the given pair is of at least a threshold quality suitable for inclusion in a dataset to be produced using the many pairs obtained by the pair scoring tool 506. Pairs which meet the threshold are further processed by the multilingual dataset collection software 412 while pairs that do not meet the threshold are culled and thus not further considered for inclusion in an eventual dataset.

The pair scoring tool 506 serves an important role in the dataset collection process to eliminate low quality pairs from further consideration. That is, the instructions generated by the instruction generation tool 504 may not always yield high-quality examples when combined with their respective English responses and prompts due to either misalignment (e.g., a mismatch) between the selected prompt-response pair or the LLM used to generate the instructions failing to generate appropriate instructions therefor. Despite this, it is still important to generate many instructions to ensure prompt diversity in the eventual dataset, and so the pair scoring tool 506 operates as a filtering mechanism for these many pairs. A scoring LLM is used by the pair scoring tool 506 to evaluate each pair by determining a score for the pair and comparing the score against the threshold. The score, S, is determined for a given pair as:

$$S = LLM ( {P}_{S} , {I}_{EN} , {R}_{EN} ) \qquad ( 3 )$$

The scoring LLM, in evaluating a given pair (I_{EN}, R_{EN}), thus takes as input the pair and a scoring prompt, P_{S}. Pairs with a score that meets (e.g., is greater than or equal to) the threshold are selected for further processing, while those that do not meet (e.g., are less than) the threshold are culled. The scoring LLM may use one or more of a number of possible rating approaches to determine the score for a given pair. In one non-limiting example, the scoring LLM may assign a score of one through five to each pair, in which one is a lowest possible score, five is a highest possible score, and a middle score of three is used as the threshold. In such an example, a score of one may indicate a total mismatch between the instruction and response and a score of give may indicate a perfect (e.g., complete) match between them.

The instruction translation tool 508 translates instructions that meet the threshold to the pair scoring tool 506 into the target language in which the responses, R, were originally obtained from the response sources 510. The translated instructions, I, in the target language may thus be produced as:

$$I = {Mt}_{EN \to X} ( {I}_{EN} ) \qquad ( 4 )$$

The instruction translation tool 508 uses a machine translation model to translate each given English instruction, I_{EN}, into a non-English instruction, I, in the target language, as described above. Similar to the machine translation model used by the response translation tool 502, the machine translation model may be an AI model prepared by the software platform that uses the multilingual dataset collection software 412 or it may be an AI model available via a third party (e.g., as an open source AI tool). Generally, the machine translation model uses X to X functionality to translate from a first language (e.g., English) into a second language (e.g., the target language). In some cases, the machine translation model used by the instruction translation tool 508 may be the same as the one used by the response translation tool 502.

The result of the instruction translation process is a training pair (I, R) which includes an instruction and the corresponding response in the target language. The many training pairs output from the instruction translation tool 508 are then combined (e.g., aggregated, arranged, juxtaposed, or the like) to produce a training dataset 514 in the target language. The training dataset 514 may thus be used for the fine-tuning training of an LLM in the target language, to prepare the LLM for prompting and response generation in that target language. The use of the training dataset 514 thus preserves the naturalness and nuances of the target language and ensures the wide diversity of corresponding instructions, all while having leveraged the power of English-focused LLMs for its collection.

Although the tools 500 through 508 are shown as separate tools, in some implementations, two or more of the tools 500 through 508 may be combined into a single tool. Although the tools 500 through 508 are shown as functionality of the multilingual dataset collection software 402 as a single piece of software, in some implementations, some or all of the tools 500 through 508 may exist outside of the multilingual dataset collection software 412, or the multilingual dataset collection software 412 may be implemented as multiple software aspects running at the same or different computing devices.

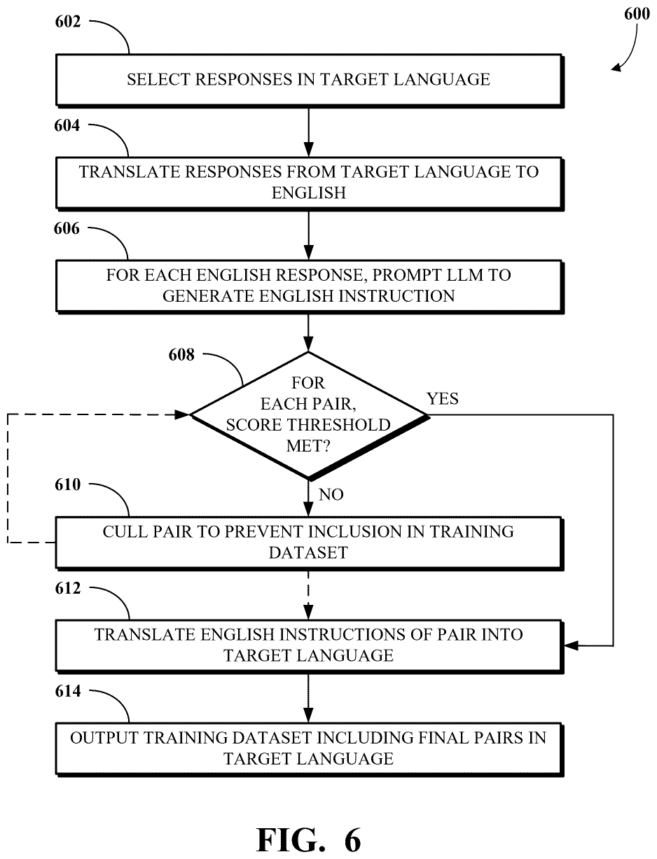

To further describe some implementations in greater detail, reference is next made to examples of techniques which may be performed by or using a system for multilingual dataset collection for LLM training. FIG. 6 is a flowchart of an example of a technique 600 for multilingual dataset collection for LLM training. The technique 600 can be executed using computing devices, such as the systems, hardware, and software described with respect to FIGS. 1-5. The technique 600 can be performed, for example, by executing a machine-readable program or other computer-executable instructions, such as routines, instructions, programs, or other code. The steps, or operations, of the technique 600, or another technique, method, process, or algorithm described in connection with the implementations disclosed herein can be implemented directly in hardware, firmware, software executed by hardware, circuitry, or a combination thereof.

For simplicity of explanation, the technique 600 is depicted and described herein as a series of steps or operations. However, the steps or operations of the technique 600 can occur in various orders and/or concurrently. Additionally, other steps or operations not presented and described herein may be used. Furthermore, not all illustrated steps or operations may be required to implement a technique in accordance with the disclosed subject matter.

At 602, responses are selected in a target language. The responses are selected from one or more responses sources, which may, for example, be various web corpora or other sources of text segments available in the target language. In some cases, selecting the responses can include pre-processing the responses using filtering criteria.

At 604, the responses are translated from the target language into English. The responses are translated using an NLP tool, such as a machine translation model, which is configured to translate text from one language to another.

At 606, for each English response, an LLM is prompted to generate an English instruction for which the English response is a valid answer. For example, the LLM may take, as input, the English response and a prompt configured to cause the LLM to generate an English instruction for the English response. Each English response and the English instruction generated for it are treated as a pair for the further processing of the technique 600.

At 608, for each pair, a determination is made as to whether a score for the pair meets a threshold. The score is determined using a scoring LLM based on the pair and a scoring prompt. The score is then compared against the threshold to determine whether the score meets the threshold. For example, the threshold may be a pre-defined value within a rating range for which scores for the pairs may be determined.

At 610, for each pair for which the score does not meet the threshold, the pair is culled to prevent inclusion of the pair in the training dataset that will later be output. As a result, the culled pair is no longer considered or otherwise processed using the technique 600. In at least some cases, after a given pair is culled, the technique 600 returns to 608 to determine whether a score for a next pair meets the threshold. Alternatively, scores may be compared against the threshold for all pairs and then pairs having scores that do not meet the threshold may be culled during a single operation or a set of consecutive culling operations. In the latter case, the technique 600 may advance directly to 612 from 610.

At 612, for each pair for which the score meets the threshold, the English instruction of the pair is translated into the target language. The instructions are translated using an NLP tool, such as a machine translation model, which is configured to translate text from one language to another. For example, the model used to translate the responses from the target language into English may also be used to translate the English instructions into the target language. Each instruction in the target language and the respective response originally obtained in the target language are treated as a final pair for the further processing of the technique 600.

At 614, a training dataset including the final pairs is output for use in training an LLM. In particular, the training dataset is collected specifically for the target language, and other training datasets may be similarly collected for other target languages. The LLM to train using the training dataset for a given target language will be trained specifically for that target language. For example, the training dataset may be an IFT dataset used in the fine-tuning of a non-English LLM. The LLM, once trained, may, for example, be used to provide software services in that target language to users of a software platform.

While the technique 600 is described above as involving a target language and English, in some implementations, the technique 600 may instead involve a first language and a second language. For example, the responses may be selected in the first language and translated into the second language. Instructions may be generated in the second language and thereafter, in accordance with the processing described in the technique 600, later translated into the first language and paired with respective ones of the responses in the first language. In such a case, the training dataset output by the technique 600 includes pairs in the first language, while the second language is instead used to collect the training dataset.

While the implementations of this disclosure are discussed with respect to software services of a software platform (e.g., a UCaaS platform), the implementations of this disclosure may additionally, or alternatively, be used in other contexts. That is, a dataset collected according to the implementations of this disclosure may be used to train an LLM or other AI model for purposes other than those directly or indirectly related to software services of a software platform. As such, the collection of a dataset according to the implementations of this disclosure imposes no limitations as to the specific functionality of the LLM that will be trained using it.

The implementations of this disclosure describe methods, systems, devices, apparatuses, and non-transitory computer readable media for multilingual dataset collection for LLM training. In some implementations, a method comprises, a non-transitory computer readable medium stores instructions operable to cause one or more processors to perform operations comprising, and/or a system comprises a memory subsystem storing instructions and processing circuitry configured to execute the instructions for: obtaining responses in a target language from one or more response sources; translating the responses from the target language into English to produce English responses; for each English response, prompting a first large language model to generate an English instruction for which the English response is a valid answer, wherein each English response and the corresponding English instruction are a pair; for each pair, determining whether a score for the pair meets a threshold; for each pair for which the score meets the threshold, translating the English instruction of the pair into the target language, wherein each instruction in the target language and the respective response in the target language are a final pair; and outputting a training dataset including the final pairs for training a second large language model.

In some implementations of the method, the non-transitory computer readable medium, and/or the system, obtaining the responses in the target language from the one or more response sources comprises: obtaining, as the responses, unlabeled data from one or more web corpora.

In some implementations of the method, the non-transitory computer readable medium, and/or the system, obtaining the responses in the target language from the one or more response sources comprises: obtaining supplementary response content including a question and answer set from a response source of the one or more response sources.

In some implementations of the method, the non-transitory computer readable medium, and/or the system, obtaining the responses in the target language from the one or more response sources comprises: processing a response source of the one or more response sources to identify and extract self-contained segments of text each including one or more sentences from the response source.

In some implementations of the method, the non-transitory computer readable medium, and/or the system, obtaining the responses in the target language from the one or more response sources comprises: pre-processing the responses using filtering criteria.

In some implementations of the method, the non-transitory computer readable medium, and/or the system, the method comprises, the operations comprise, and/or the processing circuitry is configured to execute the instructions for: for each pair, determining the score for the pair using a scoring large language model that evaluates the pair and a scoring prompt.

In some implementations of the method, the non-transitory computer readable medium, and/or the system, the method comprises, the operations comprise, and/or the processing circuitry is configured to execute the instructions for: for each pair for which the score does not meet the threshold, culling the pair to prevent the pair from inclusion in the training dataset.

In some implementations of the method, the non-transitory computer readable medium, and/or the system, the method comprises, the operations comprise, and/or the processing circuitry is configured to execute the instructions for: training the second large language model for use with a software service of a unified communications as a service software platform.

In some implementations of the method, the non-transitory computer readable medium, and/or the system, the second large language model is trained using the training dataset and the method comprises, the operations comprise, and/or the processing circuitry is configured to execute the instructions for: using the trained second large language model to perform an inference operation.

In some implementations of the method, the non-transitory computer readable medium, and/or the system, the responses are obtained as unlabeled, self-contained text data.

In some implementations of the method, the non-transitory computer readable medium, and/or the system, at least one response source is a website at which multiple language versions of content are available.

In some implementations of the method, the non-transitory computer readable medium, and/or the system, the method comprises, the operations comprise, and/or the processing circuitry is configured to execute the instructions for: determining the score for each pair using a third large language model.

In some implementations of the method, the non-transitory computer readable medium, and/or the system, the second large language model, once trained using the training dataset, is used with a unified communications as a service software platform.

In some implementations of the method, the non-transitory computer readable medium, and/or the system, each response source of the one or more response sources is a website at which multiple language versions of content are available.

In some implementations of the method, the non-transitory computer readable medium, and/or the system, the responses are filtered to cull one or more low-quality segments obtained from the one or more response sources.

In some implementations of the method, the non-transitory computer readable medium, and/or the system, for each English response, the first large language model receives, as input, the English response and a prompt as a request for the large language model to generate the English instruction and produces, as output, the English instruction.

In some implementations of the method, the non-transitory computer readable medium, and/or the system, for each pair, a scoring large language model determines the score for the pair and compares the score for the pair against the threshold.

In some implementations of the method, the non-transitory computer readable medium, and/or the system, the second large language model is used with a software service of a software platform.

As used herein, unless explicitly stated otherwise, any term specified in the singular may include its plural version. For example, “a computer that stores data and runs software,” may include a single computer that stores data and runs software or two computers-a first computer that stores data and a second computer that runs software. Also “a computer that stores data and runs software,” may include multiple computers that together stored data and run software. At least one of the multiple computers stores data, and at least one of the multiple computers runs software.

As used herein, the term “computer-readable medium” encompasses one or more computer readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

As used herein, the term “memory subsystem” includes one or more memories, where each memory may be a computer-readable medium. A memory subsystem may encompass memory hardware units (e.g., a hard drive or a disk) that store data or instructions in software form. Alternatively, or in addition, the memory subsystem may include data or instructions that are hard-wired into processing circuitry.

As used herein, processing circuitry includes one or more processors. The one or more processors may be arranged in one or more processing units, for example, a central processing unit (CPU), a graphics processing unit (GPU), or a combination of at least one of a CPU or a GPU.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory subsystem and hardware that is hard-wired into the processing circuitry.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
obtaining responses in a target language from one or more response sources;
translating the responses from the target language into English to produce English responses;
for each English response, prompting a first large language model to generate an English instruction for which the English response is a valid answer, wherein each English response and the corresponding English instruction are a pair;
for each pair, determining whether a score for the pair meets a threshold;
for each pair for which the score meets the threshold, translating the English instruction of the pair into the target language, wherein each instruction in the target language and the respective response in the target language are a final pair; and
outputting a training dataset including the final pairs for training a second large language model.

2. The method of claim 1, wherein obtaining the responses in the target language from the one or more response sources comprises:
obtaining, as the responses, unlabeled data from one or more web corpora.

3. The method of claim 1, wherein obtaining the responses in the target language from the one or more response sources comprises:
obtaining supplementary response content including a question and answer set from a response source of the one or more response sources.

4. The method of claim 1, wherein obtaining the responses in the target language from the one or more response sources comprises:
processing a response source of the one or more response sources to identify and extract self-contained segments of text each including one or more sentences from the response source.

5. The method of claim 1, wherein obtaining the responses in the target language from the one or more response sources comprises:
pre-processing the responses using filtering criteria.

6. The method of claim 1, comprising:
for each pair, determining the score for the pair using a scoring large language model that evaluates the pair and a scoring prompt.

7. The method of claim 1, comprising:
for each pair for which the score does not meet the threshold, culling the pair to prevent the pair from inclusion in the training dataset.

8. The method of claim 1, comprising:
training the second large language model for use with a software service of a unified communications as a service software platform.

9. The method of claim 1, wherein the second large language model is trained using the training dataset, the method comprising:
using the trained second large language model to perform an inference operation.

10. A non-transitory computer readable medium storing instructions operable to cause one or more processors to perform operations comprising:
obtaining responses in a target language from one or more response sources;
translating the responses from the target language into English to produce English responses;
for each English response, prompting a first large language model to generate an English instruction for which the English response is a valid answer, wherein each English response and the corresponding English instruction are a pair;
for each pair, determining whether a score for the pair meets a threshold;
for each pair for which the score meets the threshold, translating the English instruction of the pair into the target language, wherein each instruction in the target language and the respective response in the target language are a final pair; and
outputting a training dataset including the final pairs for training a second large language model.

11. The non-transitory computer readable medium of claim 10, wherein the responses are obtained as unlabeled, self-contained text data.

12. The non-transitory computer readable medium of claim 10, wherein at least one response source is a website at which multiple language versions of content are available.

13. The non-transitory computer readable medium of claim 10, the operations comprising:
determining the score for each pair using a third large language model.

14. The non-transitory computer readable medium of claim 10, wherein the second large language model, once trained using the training dataset, is used with a unified communications as a service software platform.

15. A system, comprising:
a memory subsystem storing instructions; and
processing circuitry configured to execute the instructions to:
obtain responses in a target language from one or more response sources;
translate the responses from the target language into English to produce English responses;
for each English response, prompt a first large language model to generate an English instruction for which the English response is a valid answer, wherein each English response and the corresponding English instruction are a pair;
for each pair, determine whether a score for the pair meets a threshold;
for each pair for which the score meets the threshold, translate the English instruction of the pair into the target language, wherein each instruction in the target language and the respective response in the target language are a final pair; and
output a training dataset including the final pairs for training a second large language model.

16. The system of claim 15, wherein each response source of the one or more response sources is a website at which multiple language versions of content are available.

17. The system of claim 15, wherein the responses are filtered to cull one or more low-quality segments obtained from the one or more response sources.

18. The system of claim 15, wherein, for each English response, the first large language model receives, as input, the English response and a prompt as a request for the large language model to generate the English instruction and produces, as output, the English instruction.

19. The system of claim 15, wherein, for each pair, a scoring large language model determines the score for the pair and compares the score for the pair against the threshold.

20. The system of claim 15, wherein the second large language model is used with a software service of a software platform.
